(19) United States
(12) Patent Application Publication
(10) Pub. No.: US 2010/0033031 A1
(43) Pub. Date: Feb. 11, 2010

(54) Voice coil motor for optical device

(75) Inventors: Po-Heng Lin, Hualien County (TW); Chien-Sheng Liu, Tainan County (TW); Shun-Sheng Ke, Kaohsiung City (TW); Yu-Hsiu Chang, Changhua County (TW); Ji-Bin Horng, Tainan City (TW)

Correspondence Address: QUINTERO LAW OFFICE, PC, 615 Hampton Dr, Suite A202, Venice, CA, 90291, US

(73) Assignee: INDUSTRIAL TECHNOLOGY RESEARCH INSTITUTE, Hsinchu (TW)

(21) Appl. No.: 12/251,654

(22) Filed: Oct. 15, 2008

(30) Foreign Application Priority Data
Aug. 7, 2008 (TW) TW097130029

(51) Int. Cl. H02K 41/035; G02B 7/02

(52) U.S. Cl. 310/12.16; 359/819; 310/12.19

(57) ABSTRACT

A voice coil motor. A first coil is connected to a fixed base and includes a first winding portion and a second winding portion connected to and opposite the first winding portion. A second coil is connected to the fixed base and includes a third winding portion and a fourth winding portion connected to and opposite the third winding portion. A first magnetic member is connected to a support base and includes a first magnetic pole and a second magnetic pole. The first and second magnetic poles oppose the first and third winding portions, respectively. A second magnetic member is connected to the first magnetic member and includes a third magnetic pole and a fourth magnetic pole. The third magnetic pole opposes the second winding portion and abuts the first magnetic pole. The fourth magnetic pole opposes the fourth winding portion and abuts the second magnetic pole.

### CROSS REFERENCE TO RELATED APPLICATIONS

This Application claims priority of Taiwan Patent Application No. 097130029, filed on Aug. 7, 2008, the entirety of which is incorporated by reference herein.

### BACKGROUND OF THE INVENTION

1. Field of the Invention

The invention relates to an optical device, and more particularly to a voice coil motor.

2. Description of the Related Art

Cameras disposed in cellular phones have been developed to provide high definition quality and reduced power consumption, manufacturing costs, and size. As such, actuators disposed in the cameras, for moving lens modules thereof, are critical.

Automatic displacement driving devices applied in lens modules may employ drivers providing rotational power with a rotational axis thereof paralleling an optical axis of a lens module or drivers providing movement power with a moving direction thereof paralleling the optical axis of the lens module.

An example of a driver providing rotational power with a rotational axis thereof paralleling an optical axis of a lens module is a stepping motor. The driver requires additional transmission-conversion mechanisms to enable the lens module to move along an optical axis. When the lens module arrives at a final position, no electricity is required to maintain the lens module therein. However, the driver has many components. Thus, the structure of the driver is complicated, and the size thereof cannot be reduced.

An example of a driver providing movement power with a moving direction thereof paralleling an optical axis of a lens module is a voice coil motor, a piezoelectric actuator, or a liquid lens actuator. The driver directly adjusts the position of the lens module. Compared with the driver providing rotational power, this driver has fewer components and is small. Nevertheless, there is a need to further reduce the size and enhance precision of this driver.

Taiwan Patent Publication No. 200525859 discloses a voice coil motor with two opposite non-annular magnets and multiple yoke sets. The non-annular magnets and yoke sets form a movable magnetic assembly. Part of the magnetic lines is output from the surface of the non-annular magnets and is transmitted to a plurality of magnetic-permeable shafts via the yoke sets, generating radial attraction (radial pre-compression force) between the movable magnetic assembly and the magnetic-permeable shafts. The radial attraction enables the movable magnetic assembly to slide with respect to the magnetic-permeable shafts in a smooth manner. Moreover, in the voice coil motor, generation of a voice coil force between a coil and the non-annular magnets utilizes part of the magnetic lines with the same direction and route.

Referring to FIG. 1A and FIG. 1B, Japan Patent Publication No. 2005-128405 discloses a conventional lens driving device 1. An upper spring 9 and a lower spring 11 enable precise movement of a lens module 20 and reduce friction during movement thereof. The upper spring 9 and lower spring 11 may be regarded as extensions of the coil 15, serving as conductors at two ends thereof. Specifically, in the lens driving device 1, the upper spring 9 and lower spring 11 can provide axial pre-compression force to the lens module 20. Thus, the lens module 20 can be easily positioned in a specific position when the coil 15 is energized by application of a current. Nevertheless, as the lens driving device 1 must comprise a yoke 3 providing magnetic-permeable functions, the size and manufacturing costs thereof cannot be reduced.

Moreover, some conventional voice coil motors often comprise permanent magnets, magnetic-permeable yokes, and coils. No matter how the permanent magnets are magnetized, to enhance utilization of magnetic flux in the voice coil motors, the coils must be disposed between the permanent magnets and the magnetic-permeable yokes or between the magnetic-permeable yokes constructing magnetic routes. In the conventional voice coil motors, the magnetic-permeable yokes occupy a space and two gaps exist between a movable part and a fixed part. One gap exists between the permanent magnets and the coil while the other exists between the magnetic-permeable yokes and the coil, adversely affecting miniaturization of the voice coil motors. For example, the aforementioned conventional voice coil motors are disclosed by Japan Patent Publication No. 2003-207708A, Japan Patent Publication No. 2005-128405A, Japan Patent Publication No. 2006-220776A, U.S. Pat. No. 5,220,461, Taiwan Patent Publication No. 200525859, and Taiwan Patent No. 176799.

Moreover, in a conventional voice coil motor, a lens module, a permanent magnet, a magnetic-permeable yoke, and a coil provide an overlapped central axis and are radially (or sideward) arranged. To pass the lens module, permanent magnet, and magnetic-permeable yoke through the coil, the coil must provide a hollow annular portion occupying a large space. Here, winding turns of the coil providing the large hollow annular portion are limited, thereby limiting the magnitude of a generated voice coil force. Furthermore, the overall strength of the coil providing the large hollow annular portion is insufficient, causing deformation during assembly thereof, and further resulting in poor production of the voice coil motor. For example, the aforementioned conventional voice coil motor is disclosed by Japan Patent Publication No. 2003-207708A, Japan Patent Publication No. 2005-128405A, Japan Patent Publication No. 2006-220776A, U.S. Pat. No. 5,220,461, Taiwan Patent Publication No. 200525859, and Taiwan Patent No. 176799.

Moreover, in a conventional voice coil motor, a permanent magnet is comprised of multiple sub-magnets to enhance utilization of magnetic lines therefrom and facilitate magnetization thereof. The sub-magnets are separated from one another and are assembled on a member by attraction of a magnetic-permeable yoke. However, attraction or repulsion between the sub-magnets increases difficulties in assembling the permanent magnet. For example, the aforementioned conventional voice coil motor is disclosed by Japan Patent Publication No. 2003-207708A, Japan Patent Publication No. 2005-128405A, Japan Patent Publication No. 2006-220776A, U.S. Pat. No. 5,220,461, Taiwan Patent Publication No. 200525859, and Taiwan Patent No. 176799.

### BRIEF SUMMARY OF THE INVENTION

A detailed description is given in the following embodiments with reference to the accompanying drawings.

An exemplary embodiment of the invention provides a voice coil motor comprising a fixed base, a first coil, a second coil, a support base, a first magnetic member, and a second magnetic member. The first coil is connected to the fixed base and comprises a first winding portion and a second winding portion connected to and opposite the first winding portion. A current direction in the first winding portion is opposite to that in the second winding portion. The second coil is connected to the fixed base and comprises a third winding portion and a fourth winding portion connected to and opposite the third winding portion. A current direction in the third winding portion is opposite to that in the fourth winding portion. The first magnetic member is connected to the support base and comprises a first magnetic pole and a second magnetic pole. A magnetization direction of the first magnetic member is perpendicular to a moving direction of the support base and parallels central axes of the first and second coils. The first magnetic pole opposes the first winding portion of the first coil. The second magnetic pole opposes the third winding portion of the second coil. The second magnetic member is connected to the first magnetic member and comprises a third magnetic pole and a fourth magnetic pole. A magnetization direction of the second magnetic member is perpendicular to the moving direction of the support base and parallels the central axes of the first and second coils. The third magnetic pole opposes the second winding portion of the first coil and abuts the first magnetic pole of the first magnetic member. The fourth magnetic pole opposes the fourth winding portion of the second coil and abuts the second magnetic pole of the first magnetic member. The polarity of the first magnetic pole is opposite to that of the third magnetic pole. The polarity of the second magnetic pole is opposite to that of the fourth magnetic pole. When the first and second coils are electrified, the first magnetic pole interacts with the first winding portion to generate a first force, the second magnetic pole interacts with the third winding portion to generate a second force, the third magnetic pole interacts with the second winding portion to generate a third force, and the fourth magnetic pole interacts with the fourth winding portion to generate a fourth force. The first, second, third, and fourth forces drive the support base, first magnetic member, and second magnetic member to move perpendicular to the magnetization directions of the first and second magnetic members.

The voice coil motor further comprises at least one guide bar connected to the fixed base. The support base is movably fit on the guide bar.

The first and second coils are formed by integral winding.

The first coil is connected to the second coil in series.

The first coil is connected to the second coil in parallel.

The first and second magnetic members are integrally formed and magnetized, respectively.

The voice coil motor further comprises a position sensor connected to the fixed base and opposing the first and second magnetic members, detecting movement of the first and second magnetic members.

The position sensor comprises a Hall sensor, a magnetic resistance sensing element, an electrical sensing element, or a light sensing element.

### BRIEF DESCRIPTION OF THE DRAWINGS

The invention can be more fully understood by reading the subsequent detailed description and examples with references made to the accompanying drawings, wherein:

FIG. 1A is a schematic cross section of a conventional lens driving device;

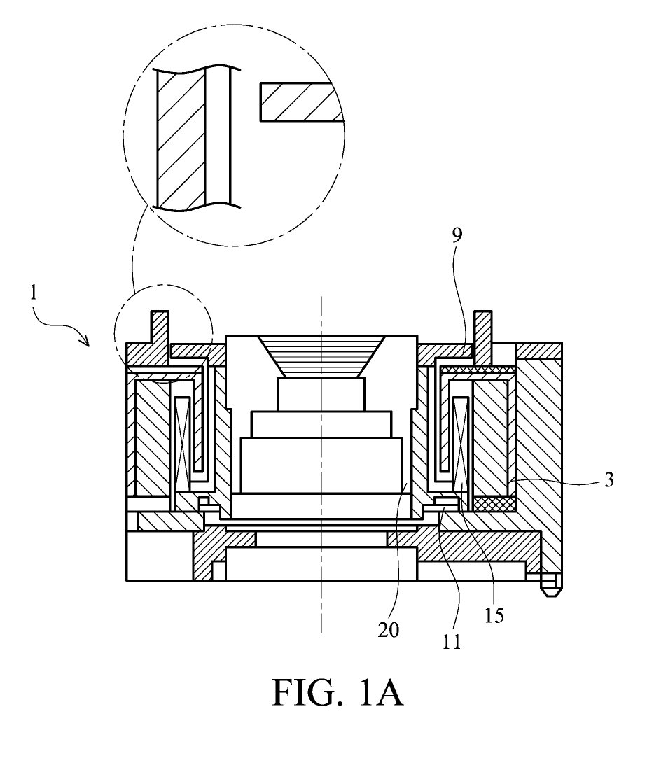

FIG. 1B is an exploded perspective view of the conventional lens driving device of FIG. 1A;

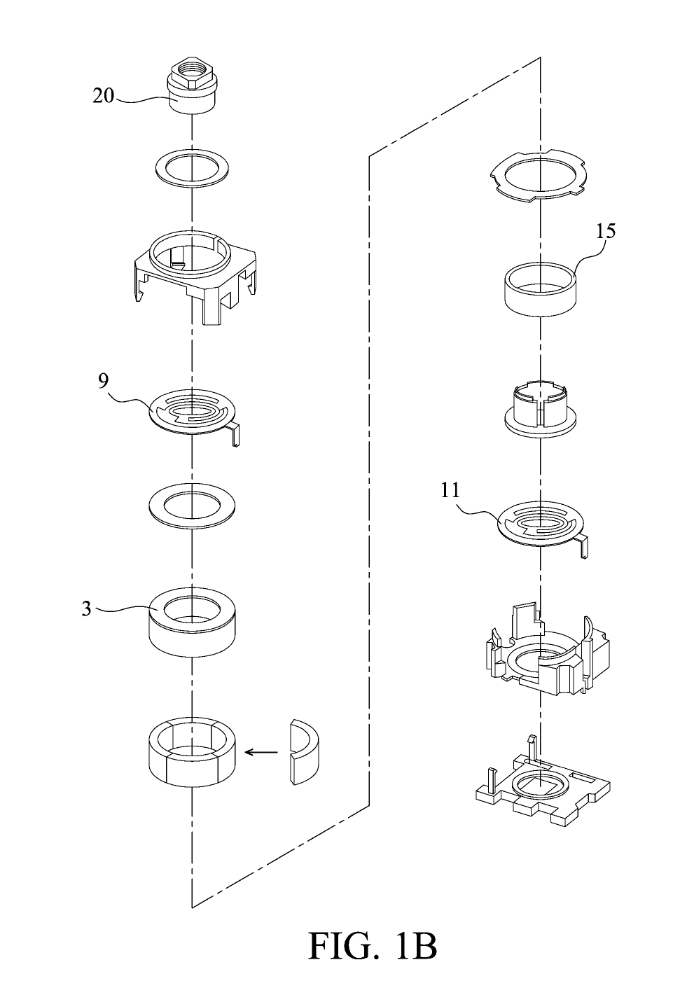

FIG. 2A is an exploded perspective view of a voice coil motor of the invention;

FIG. 2B is a perspective assembly view of the voice coil motor of the invention;

FIG. 3 is a schematic cross section of FIG. 2B;

FIG. 4 is a perspective assembly view of the present voice coil motor, a guide bar, a position sensor, and a lens module;

FIG. 5 is a schematic cross section of FIG. 4; and

FIG. 6 is a schematic cross section of a support base of the present voice coil motor and the lens module.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

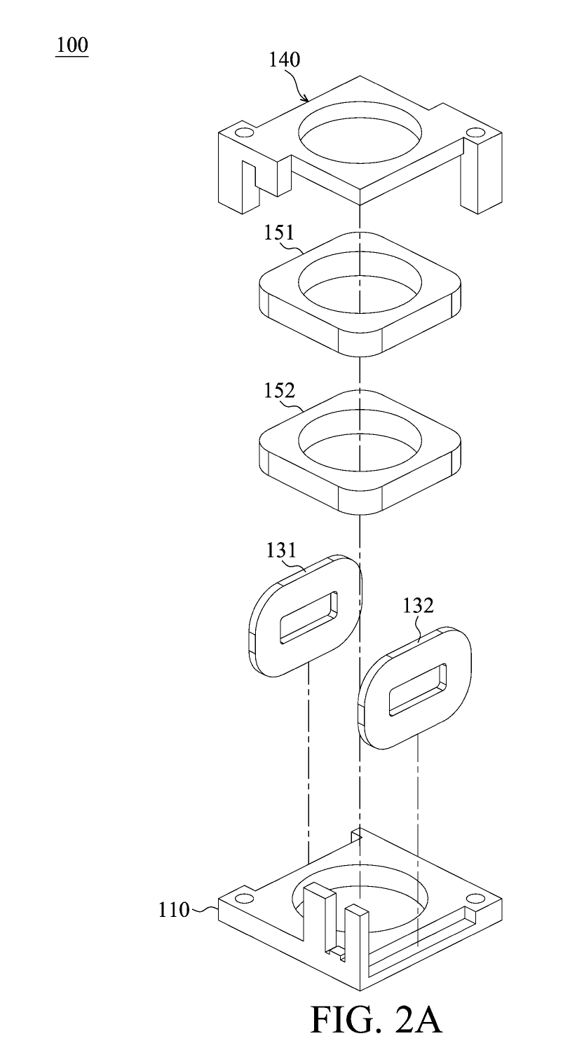

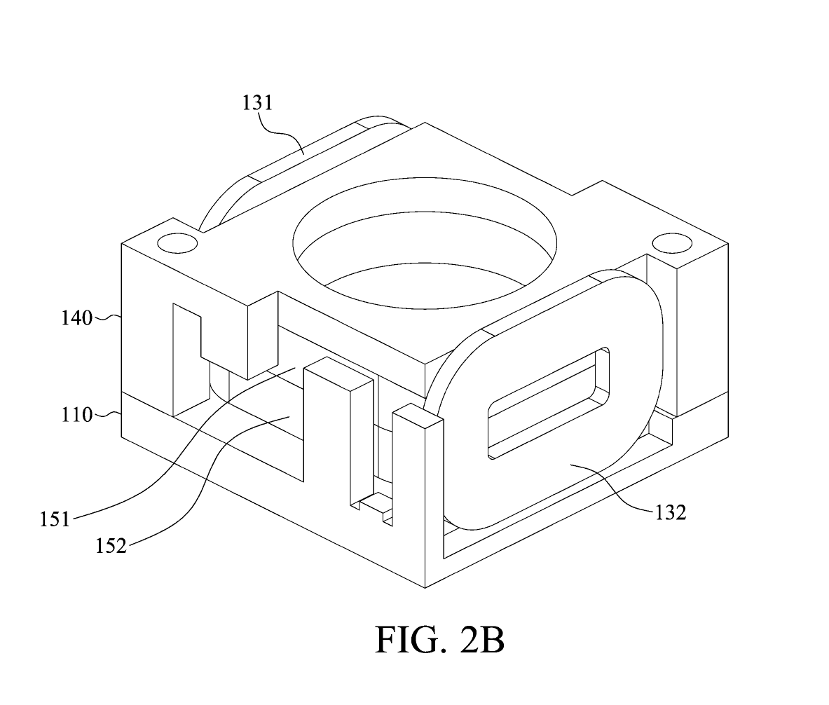

Referring to FIG. 2A and FIG. 2B, a voice coil motor 100 drives a lens module of a camera to perform zoom movement and comprises a fixed base 110, a first coil 131, a second coil 132, a support base 140, a first magnetic member 151, and a second magnetic member 152. The fixed base 110, first coil 131, and second coil 132 may be regarded as fixed members of the voice coil motor 100, while the support base 140, first magnetic member 151, and second magnetic member 152 may be regarded as movable members thereof.

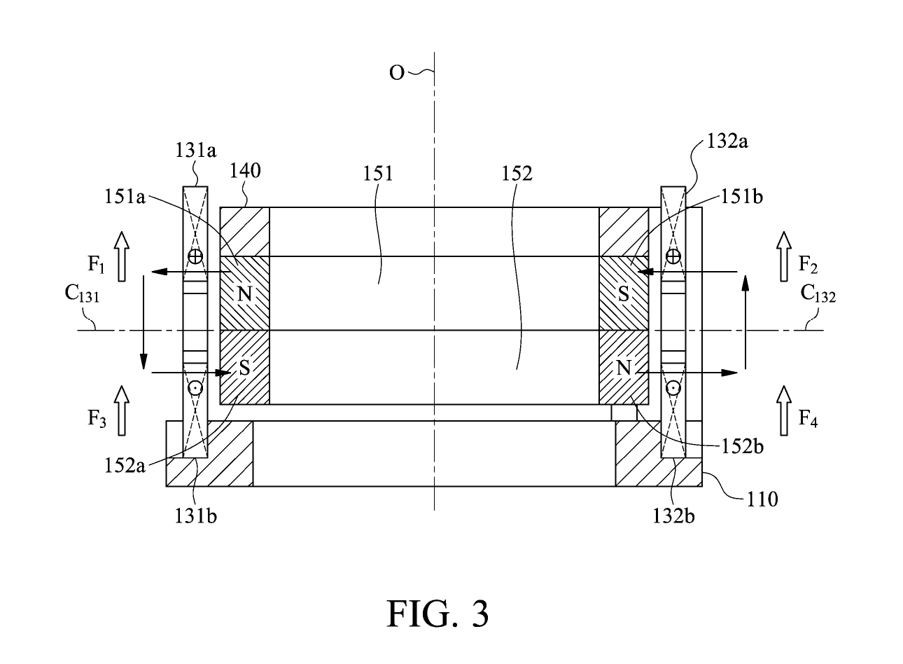

As shown in FIGS. 2A, 2B, and 3, the first coil 131 is connected to the fixed base 110 and comprises a first winding portion 131a and a second winding portion 131b connected to and opposite the first winding portion 131a. Specifically, as the first winding portion 131a and second winding portion 131b construct the loop of the first coil 131, a current direction in the first winding portion 131a is opposite to that in the second winding portion 131b.

The second coil 132 is connected to the fixed base 110 and comprises a third winding portion 132a and a fourth winding portion 132b connected to and opposite the third winding portion 132a. Similarly, as the third winding portion 132a and fourth winding portion 132b construct the loop of the second coil 132, a current direction in the third winding portion 132a is opposite to that in the fourth winding portion 132b. In this embodiment, the first coil 131 and second coil 132 are formed by integral winding. Moreover, the first coil 131 may be connected to the second coil 132 in series or parallel.

The first magnetic member 151 is connected to the support base 140. Specifically, a magnetization direction of the first magnetic member 151 is perpendicular to a moving direction of the support base 140 and parallels a central axis C₁₃₁ of the first coil 131 and a central axis C₁₃₂ of the second coil 132. Namely, the first magnetic member 151 is magnetized by a single-sided unipolar magnetization method. Additionally, as shown in FIG. 3, the first magnetic member 151 comprises a first magnetic pole 151a and a second magnetic pole 151b. The first magnetic pole 151a opposes the first winding portion 131a of the first coil 131, and the second magnetic pole 151b opposes the third winding portion 132a of the second coil 132. Moreover, the first magnetic member 151 may be a permanent magnet.

As shown in FIGS. 2A, 2B, and 3, the second magnetic member 152 is connected to the first magnetic member 151. Similarly, a magnetization direction of the second magnetic member 152 is perpendicular to the moving direction of the support base 140 and parallels the central axis C₁₃₁ of the first coil 131 and the central axis C₁₃₂ of the second coil 132. Namely, the second magnetic member 152 is magnetized by the single-sided unipolar magnetization method. Additionally, as shown in FIG. 3, the second magnetic member 152 comprises a third magnetic pole 152a and a fourth magnetic pole 152b. The third magnetic pole 152a opposes the second winding portion 131b of the first coil 131 and abuts the first magnetic pole 151a of the first magnetic member 151. The fourth magnetic pole 152b opposes the fourth winding portion 132b of the second coil 132 and abuts the second magnetic pole 151b of the first magnetic member 151. Specifically, the polarity of the first magnetic pole 151a is opposite to that of the third magnetic pole 152a, and the polarity of the second magnetic pole 151b is opposite to that of the fourth magnetic pole 152b. Moreover, the second magnetic member 152 may be a permanent magnet.

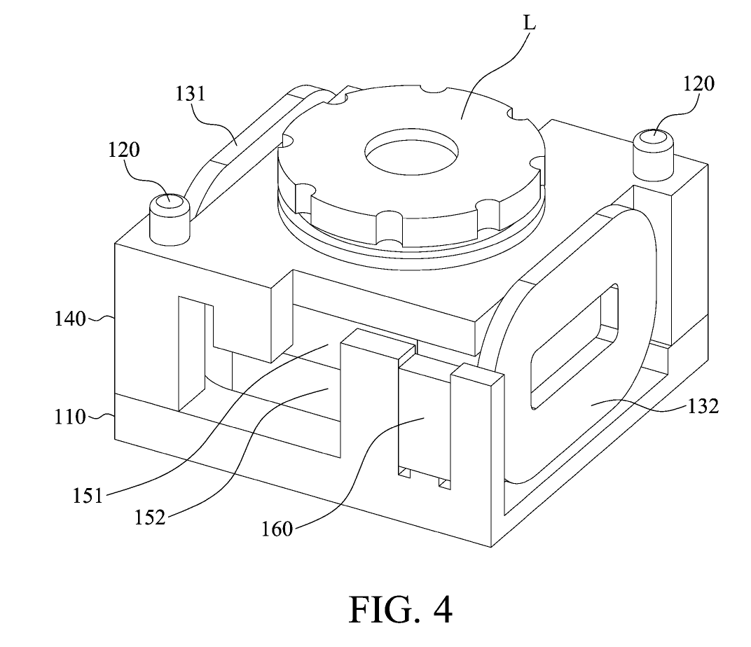

As shown in FIG. 4, the support base 140 is movably fit on two guide bars 120. Specifically, the support base 140 comprises two through holes 141 in which the guide bars 120 are respectively fit. Namely, the support base 140 is movably fit on two guide bars 120 by the through holes 141, such that the movable members can stably and linearly move with respect to the fixed members.

A position sensor 160 is connected to the fixed base 110 and opposes the first magnetic member 151 and second magnetic member 152, detecting movement of the first magnetic member 151 and second magnetic member 152. Here, the position sensor 160 may comprise a Hall sensor, a magnetic resistance sensing element, an electrical sensing element, or a light sensing element. For example, being a Hall sensor or magnetic resistance sensing element, the position sensor 160 detects the intensity of a magnetic field, in a fixed position in the voice coil motor 100, provided by the first magnetic member 151 and/or second magnetic member 152. Here, the intensity of the magnetic field, in the fixed position, provided by the first magnetic member 151 and/or second magnetic member 152 is related to displacement of the first magnetic member 151 and/or second magnetic member 152. By combining the position sensor 160 with a positioning controller (not shown), closed-loop positioning control can be obtained. The moving position of the support base 140, first magnetic member 151, and second magnetic member 152 (or the relative position of the support base 140 and fixed base 110) is thus controlled. As the closed-loop positioning control belongs to a prior art, detailed description thereof is omitted for brevity.

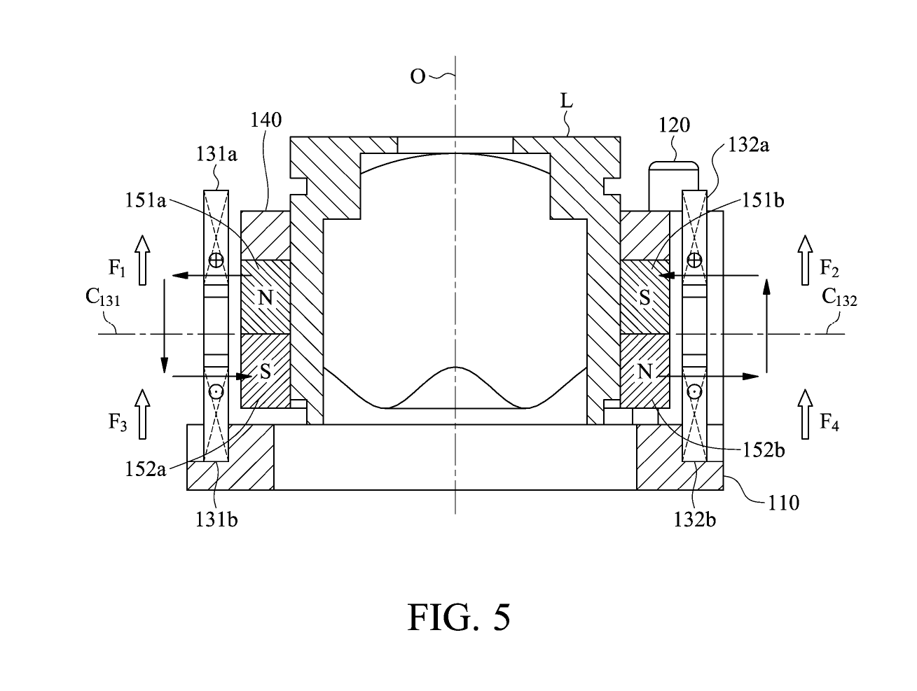

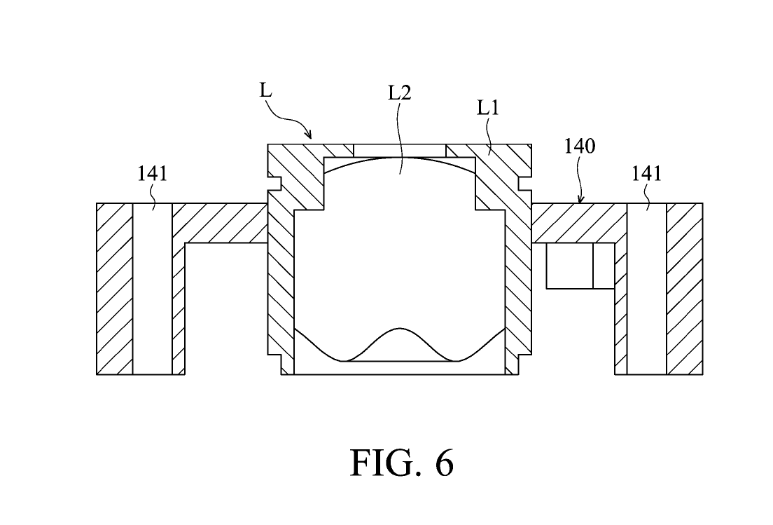

Moreover, as shown in FIG. 4 and FIG. 5, the support base 140 can support or carry a lens module L. Here, as shown in FIG. 6, the lens module L comprises a holder L1 and an optical lens assembly L2. The holder L1 is connected to the support base 140 and holds the optical lens assembly L2. In this embodiment, the holder L1 and support base 140 may be integrally formed with the same material, and the optical lens assembly L2 may be connected to the support base 140.

Accordingly, the first magnetic member 151 and second magnetic member 152 provide closed magnetic lines vertically passing through the first winding portion 131a and second winding portion 131b of the first coil 131 and the third winding portion 132a and fourth winding portion 132b of the second coil 132. For example, referring to FIG. 3, the first magnetic pole 151a and second magnetic pole 151b of the first magnetic member 151 are respectively an N pole and an S pole, the third magnetic pole 152a and fourth magnetic pole 152b of the second magnetic member 152 are respectively an S pole and an N pole, the current directions in the first winding portion 131a and second winding portion 131b of the first coil 131 are respectively referred to as flowing in and flowing out, the current directions in the third winding portion 132a and fourth winding portion 132b of the second coil 132 are respectively referred to as flowing in and flowing out, the direction of the magnetic lines vertically passing through the first winding portion 131a is opposite to that vertically passing through the second winding portion 131b, and the direction of the magnetic lines vertically passing through the third winding portion 132a is opposite to that vertically passing through the fourth winding portion 132b. When the first coil 131 and second coil 132 are respectively electrified (or energized by application of a current), according to the Lorentz's law, the first magnetic pole 151a interacts with the first winding portion 131a to generate a first force F₁, the second magnetic pole 151b interacts with the third winding portion 132a to generate a second force F₂, the third magnetic pole 152a interacts with the second winding portion 131b to generate a third force F₃, and the fourth magnetic pole 152b interacts with the fourth winding portion 132b to generate a fourth force F₄. Here, the directions of the first force F₁, second force F₂, third force F₃, and fourth force F₄ are the same. Accordingly, driven by the resultant of the first force F₁, second force F₂, third force F₃, and fourth force F₄, the support base 140, first magnetic member 151, and second magnetic member 152 can move perpendicular to the magnetization directions of the first magnetic member 151 and second magnetic member 152.

When the voice coil motor 100 is employed to drive the lens module L of a camera to perform zoom movement (i.e. when the voice coil motor 100 is combined with the lens module L to form an optical device), the construction is shown in FIG. 4 and FIG. 5. The lens module L is provided with an optical axis O. The magnetization directions of the first magnetic member 151 and second magnetic member 152 are perpendicular to the optical axis O. At this point, the resultant of the first force F₁, second force F₂, third force F₃, and fourth force F₄ generated according to the Lorentz's law and parallel to the optical axis O drives the lens module L, support base 140, first magnetic member 151, and second magnetic member 152 to move along the optical axis O (or perpendicular to magnetization directions of the first magnetic member 151 and second magnetic member 152).

Moreover, the disclosed voice coil motor is not limited to having two magnetic members connected to each other. Namely, the first magnetic member 151 and second magnetic member 152 may be integrated into a single magnetic member magnetized by a single-sided double-polar magnetization method to provide four magnetic poles respectively corresponding to the first winding portion 131a, second winding portion 131b, third winding portion 132a, and fourth winding portion 132b. Accordingly, the voice coil motor with the single magnetic member can achieve the same effect as the voice coil motor 100.

In conclusion, the disclosed voice coil motors are summarized as follows. Based upon the aforementioned arrangement of the coils and magnetic members, the magnetic lines provided with different directions or routes can be simultaneously utilized, thereby increasing the resultant (first force F₁, second force F₂, third force F₃, and fourth force F₄) generated according to the Lorentz's law. Further, Based upon the aforementioned arrangement of the coils and magnetic members, the magnetic lines provided with different directions or routes can be simultaneously utilized, thereby enhancing the utilization of the magnetic flux. Thus, the voice coil motors can generate a sufficient voice coil force in the absence of a magnetic-permeable yoke, such that the size and manufacturing costs of the voice coil motors can be reduced. Moreover, as central hollow portions of the coils are not penetrated by members, the size of the central hollow portions is reduced. Namely, the coils are provided with increased winding turns, enhancing the voice coil force and providing enhanced overall strength. Alternatively, as the central hollow portions of the coils are penetrated by no member, the size of the central hollow portions is reduced, thereby reducing the overall size of the voice coil motors. Additionally, only one gap exists between the magnetic members (movable members) and the coils (fixed members), such that the voice coil motors can be miniaturized. Furthermore, as disposition of the position sensor is not confined by the size and position of the coils, the arrangement of the members in the voice coil motors is flexible, advantageously reducing the overall size of the voice coil motors.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A voice coil motor, comprising:
a fixed base;
a first coil connected to the fixed base and comprising a first winding portion and a second winding portion connected to and opposite the first winding portion, wherein a current direction in the first winding portion is opposite to that in the second winding portion;
a second coil connected to the fixed base and comprising a third winding portion and a fourth winding portion connected to and opposite the third winding portion, wherein a current direction in the third winding portion is opposite to that in the fourth winding portion;
a support base;
a first magnetic member connected to the support base and comprising a first magnetic pole and a second magnetic pole, wherein a magnetization direction of the first magnetic member is perpendicular to a moving direction of the support base and parallels central axes of the first and second coils, the first magnetic pole opposes the first winding portion of the first coil, and the second magnetic pole opposes the third winding portion of the second coil; and
a second magnetic member connected to the first magnetic member and comprising a third magnetic pole and a fourth magnetic pole, wherein a magnetization direction of the second magnetic member is perpendicular to the moving direction of the support base and parallels the central axes of the first and second coils, the third magnetic pole opposes the second winding portion of the first coil and abuts the first magnetic pole of the first magnetic member, the fourth magnetic pole opposes the fourth winding portion of the second coil and abuts the second magnetic pole of the first magnetic member, the polarity of the first magnetic pole is opposite to that of the third magnetic pole, the polarity of the second magnetic pole is opposite to that of the fourth magnetic pole, and when the first and second coils are electrified, the first magnetic pole interacts with the first winding portion to generate a first force, the second magnetic pole interacts with the third winding portion to generate a second force, the third magnetic pole interacts with the second winding portion to generate a third force, the fourth magnetic pole interacts with the fourth winding portion to generate a fourth force, and the first, second, third, and fourth forces drive the support base, first magnetic member, and second magnetic member to move perpendicular to the magnetization directions of the first and second magnetic members.

2. The voice coil motor as claimed in claim 1, further comprising at least one guide bar connected to the fixed base, wherein the support base is movably fit on the guide bar.

3. The voice coil motor as claimed in claim 1, wherein the first and second coils are formed by integral winding.

4. The voice coil motor as claimed in claim 1, wherein the first coil is connected to the second coil in series.

5. The voice coil motor as claimed in claim 1, wherein the first coil is connected to the second coil in parallel.

6. The voice coil motor as claimed in claim 1, wherein the first and second magnetic members are integrally formed and magnetized, respectively.

7. The voice coil motor as claimed in claim 1, further comprising a position sensor connected to the fixed base and opposing the first and second magnetic members, detecting movement of the first and second magnetic members.

8. The voice coil motor as claimed in claim 7, wherein the position sensor comprises a Hall sensor, a magnetic resistance sensing element, an electrical sensing element, or a light sensing element.

9. An optical device, comprising:
a fixed base;
a first coil connected to the fixed base and comprising a first winding portion and a second winding portion connected to and opposite the first winding portion, wherein a current direction in the first winding portion is opposite to that in the second winding portion;
a second coil connected to the fixed base and comprising a third winding portion and a fourth winding portion connected to and opposite the third winding portion, wherein a current direction in the third winding portion is opposite to that in the fourth winding portion;
a support base;
a lens module comprising a holder and an optical lens assembly, wherein the holder is connected to the support base and holds the optical lens assembly;
a first magnetic member connected to the support base and comprising a first magnetic pole and a second magnetic pole, wherein a magnetization direction of the first magnetic member is perpendicular to a moving direction of the support base and parallels central axes of the first and second coils, the first magnetic pole opposes the first winding portion of the first coil, and the second magnetic pole opposes the third winding portion of the second coil; and
a second magnetic member connected to the first magnetic member and comprising a third magnetic pole and a fourth magnetic pole, wherein a magnetization direction of the second magnetic member is perpendicular to the moving direction of the support base and parallels the central axes of the first and second coils, the third magnetic pole opposes the second winding portion of the first coil and abuts the first magnetic pole of the first magnetic member, the fourth magnetic pole opposes the fourth winding portion of the second coil and abuts the second magnetic pole of the first magnetic member, the polarity of the first magnetic pole is opposite to that of the third magnetic pole, the polarity of the second magnetic pole is opposite to that of the fourth magnetic pole, and when the first and second coils are electrified, the first magnetic pole interacts with the first winding portion to generate a first force, the second magnetic pole interacts with the third winding portion to generate a second force, the third magnetic pole interacts with the second winding portion to generate a third force, the fourth magnetic pole interacts with the fourth winding portion to generate a fourth force, and the first, second, third, and fourth forces drive the support base, first magnetic member, second magnetic member, and lens module to move perpendicular to the magnetization directions of the first and second magnetic members.

10. The optical device as claimed in claim 9, wherein the holder and support base are integrally formed, and the optical lens assembly is connected to the support base.

11. The optical device as claimed in claim 9, further comprising at least one guide bar connected to the fixed base, wherein the support base is movably fit on the guide bar.

12. The optical device as claimed in claim 9, wherein the first and second coils are formed by integral winding.

13. The optical device as claimed in claim 9, wherein the first coil is connected to the second coil in series.

14. The optical device as claimed in claim 9, wherein the first coil is connected to the second coil in parallel.

15. The optical device as claimed in claim 9, wherein the first and second magnetic members are integrally formed and magnetized, respectively.

16. The optical device as claimed in claim 9, further comprising a position sensor connected to the fixed base and opposing the first and second magnetic members, detecting movement of the first and second magnetic members.

17. The optical device as claimed in claim 16, wherein the position sensor comprises a Hall sensor, a magnetic resistance sensing element, an electrical sensing element, or a light sensing element.
